(19) United States
(12) Patent Application Publication
(10) Pub. No.: US 2007/0232173 A1
(43) Pub. Date: Oct. 4, 2007

(54) Non-plain-woven laminated structures

(76) Inventor: Allan D. Bain, Missouri City, TX (US)

Correspondence Address: SCHUBERT OSTERRIEDER & NICKELSON PLLC, 6013 CANNON MTN DR, S14, AUSTIN, TX, 78749, US

(21) Appl. No.: 11/225,597

(22) Filed: Sep. 13, 2005

(51) Int. Cl. B32B 5/26; B32B 27/12

(52) U.S. Cl. 442/239; 442/241; 442/242; 442/243; 442/246; 442/255; 442/261; 442/263; 428/911

(57) ABSTRACT

Laminated structures are disclosed for antiballistic applications or other high-modulus, high-strength composite applications. One embodiment includes a first array having first, non-plain-woven fibers in a substantially A-B orientation. Further, the embodiment includes a second array having second, non-plain-woven fibers also in a substantially A-B orientation. Further still, the laminate structure includes a securing material for adjoining the first array and the second array so that the laminate structure has a substantially A-B/A-B orientation. In other embodiments, the laminate structure may optionally include additional, non-plain woven arrays, wherein each array's constituent fibers are in a substantially A-B orientation, and adjoined with the security material and in a manner to continue the overall A-B repeated orientation. Finally, the laminate structure optionally and externally includes a water-repellant coating.

### FIELD OF INVENTION

The invention generally relates to penetration-resistant materials, and, in particular, to non-plain-woven, laminated structures capable of use in antiballistic and other high-modulus, high-strength applications.

### BACKGROUND

Throughout history, various types of materials have been used as body armors to protect humans from injury in combat and other hostile situations. From earliest times, protective vests were made from animal skins and hides. As time and technology progressed, wooden and metal vests were used as body protection. These armors were cumbersome, heavy and uncomfortable, which collectively suggested a desired need for soft, more effective, and lightweight body armors. Modern civilization has responded and continues to respond to this need through research and development of high-performance, laminated fibers (“laminates”) which have extinguished former and sole reliance on wood and animal hides to provide protective applications.

Today, body armor laminates are often constructed from one or more layers of ballistic resistant material(s), such as polyethylene, polyolefin and aramid fibers, sometimes in combination with resin, to produce a wearable, soft body armor laminate that protects a wearer against high-velocity bullets and fragments. In addition, these soft body armor laminates are occasionally amplified in strength by removably or permanently appending them to a ballistic panel or substrate, otherwise more generically known as a ballistic composite, such as metal or ceramic.

Despite advances in the antiballistic laminates, whether used in soft or hard body armor, problems remain in providing their underlying purpose, i.e., antiballistic protection against “hits,” whether viewed as “fair” or “unfair” according to known industry standard tests definitions. In the real world, criminals, terrorists, and antiballistic vest wearers are not concerned with whether a bullet is a “fair” or “unfair” hit if the bullet kills or mutilates the antiballistic laminate wearer. In addition, another problem stems from manufacturing impracticalities associated with some existing antiballistic laminates' inability to be produced in rolled goods format, which may limit manufacturing functionality, significantly impede ultimate production efficiency, and/or cause unwieldy transportation and storage issues. Still another problem is absorption of water by antiballistic materials, a problem known to lower ballistic performance by as much as 40% as compared to an anhydrous version of some antiballistic materials.

In light of the above-listed and known example problems, a need, therefore, exists for improved laminate structures that are capable of enhanced antiballistic applications while being rollable and/or water-repellant.

### SUMMARY OF THE INVENTION

Embodiments of the invention generally provide laminate structures capable of antiballistic applications or other high-modulus, high-strength composite applications, such as the formation of intricately shaped or molded materials. In one embodiment, the laminate structure includes a first array having first, non-plain-woven fibers in a substantially A-B or 0/90 degree orientation. That is, the component fibers of the non-plain-woven fibers are substantially arranged in an A-B or 0/90 degree orientation with respect to each other. Further, the laminate structure includes a second array having second, non-plain-woven fibers also in a substantially A-B or 0/90 degree orientation. Further still, the laminate structure includes a securing material for adjoining the first array and the second array so that the laminate structure has a substantially A-B/A-B orientation, i.e., the first array having an A-B orientation cross-plied and adjoined to the second array, which also has an A-B orientation, so that the finished product has a substantially overall A-B/A-B orientation. Finally, the laminate structure optionally and externally includes a water-repellant coating, which may penetrate the unbonded fibers of the laminate structure.

The laminate structure may optionally include additional, non-plain woven arrays, such as a third, fourth, fifth, etc. array. Each such additional array has a substantially A-B or 0/90 degree orientation of its constituent fibers, and each is adjoined to the laminate structure's arrays with the security material, such as a film or resin.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1A depicts a plain weave pattern as discussed in and in accordance with the disclosed invention.

FIG. 1B depicts a twill weave, which is a twill-based weave, as discussed in and in accordance with the disclosed invention.

FIG. 1C depicts a satin weave, which is a twill-based weave, as discussed in and in accordance with the disclosed invention.

FIG. 2 depicts a cross-sectional, exploded side view of an embodiment of a two, non-plain-woven arrays, each of which has a substantially A-B orientation, that are cross-piled to form a laminate structure having a substantially A-B/A-B orientation secured in place by a securing material, as well as having water-repellant coating applied to the exterior portions of the laminate structure, as discussed in and in accordance with the disclosed invention.

FIG. 3 depicts an embodiment of an antiballistic device 300, as discussed in and in accordance with the disclosed invention.

### DETAILED DESCRIPTION OF THE EMBODIMENTS

The following is a detailed description of example embodiments of the invention depicted in the accompanying drawings. The embodiments are examples and are in such detail so as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, laminate structures for antiballistic applications or other high-modulus, high-strength composite applications are contemplated. Embodiments include a first array having first, non-plain-woven fibers in a substantially A-B or 0/90 degree orientation. That is, the component fibers of the non-plain-woven fibers are substantially arranged in an A-B or 0/90 degree orientation with respect to each other. Further, embodiments include a second array having second, non-plain-woven fibers also in a substantially A-B or 0/90 degree orientation. Although used interchangeably, herein, a 0/90 degree orientation is sometimes used to refer to a fiber bundle's directions in an array, and an A-B orientation is sometimes used to refer to the orientation of each array to each other in a multi-plied array system, i.e., a single array terminology versus a multi-plied array terminology, respectively. Further still, embodiments include a securing material for adjoining the first array and the second array so that the laminate structure has a substantially A-B/A-B orientation, i.e., the first array having an A-B orientation cross-plied and adjoined to the second array, which also has an A-B orientation, so that the finished product has a substantially overall A-B/A-B orientation. In some embodiments, the laminate structure may optionally include additional, non-plain woven arrays, such as a third, fourth, fifth, etc. array. Each such additional array has a substantially A-B or 0/90 degree orientation of its constituent fibers, and each is adjoined to the laminate structure's arrays with the security material, such as a film or resin. In some embodiments, the laminate structure may include a water-repellant coating on the structure's exterior, especially useful if the underlying laminate's array's materials are hygroscopic. Finally, in some embodiments, the laminate structure may also include at least one plain-weave filament along at least one of the two orientations, i.e., the A and/or B direction (the warp and/or weft) of the substantially A-B orientation.

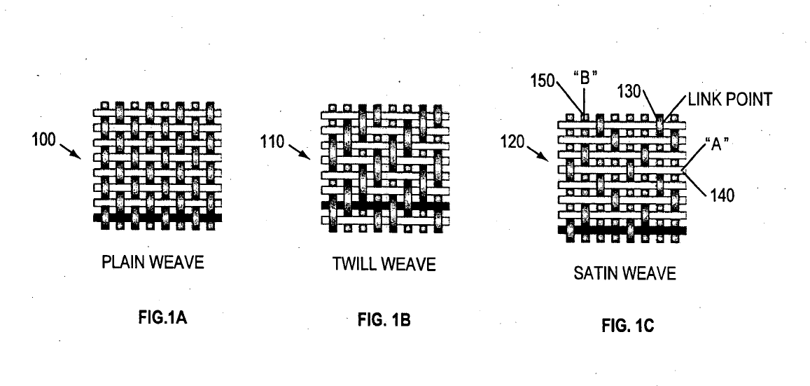

Turning now to FIGS. 1A-1C, known weave patterns for the fibers of materials, such as aramids, high-density polyethylenes, poly-p-phenylenebenzobisoxazoles, Twaron®, Zylon®, M5®, and Kevlar®, are depicted. Woven materials are produced by interlacing the warp (0°) and the weft (90°) fibers, respectively depicted as “A” 140 and “B” 150 in FIG. 1C, in a particular weave pattern. The resultant mechanical interlocking of the warp and the weft fibers provides the material with its integrity; each such interlocking point is also known as a link point 130.

Now, with respect to the specific figures, FIG. 1A depicts a plain weave, wherein the depicted A-B weave pattern is one under, one over, one under, and so on. The materials used in this invention's disclosure do not use a plain weave 100. A material having plain-woven 100 fibers is symmetrical, and provides good stability and reasonable porosity. However, plain-woven 100 materials are less drapable than other weave patterns, and their high level of fiber crimp imparts relatively low mechanical properties as compared with the other weave patterns.

The materials for use in the disclosed invention use a twill-based weave pattern, such as the twill weave 110 pattern depicted in FIG. 1B, or, even better for the disclosed invention, the modified twill weave pattern known as a satin weave 120 as depicted in FIG. 1C. In a twill weave 110 pattern, one or more warp fibers alternately weave over and under two or more weft fibers in a regular repeated manner. This produces a visual effect of a straight or broken diagonal ‘rib’ to the fabric. Superior wet out and drape is seen in the twill weave 110 pattern as compared to the plain weave 100 with only a small reduction in stability. With reduced crimp, the fabric of a twill weave 110 also has a smoother surface and slightly higher mechanical properties than a plain weave 100.

Satin weaves 120 are fundamentally twill weaves 110 modified to produce fewer intersections of warp and weft. The ‘harness’ (“H”) number used in the designation of a satin weave 120 is the total number of fibers crossed and passed under, before the fiber repeats the pattern. Examples of such harnessed-numbered satin weaves 120 are 4H, 8H, and 20H, and FIG. 1C, itself, is an example of a 4H satin weave 120 because one fiber is crossed and three passed under before the fiber repeats the pattern; that is one plus three equals four, the H designates this as a satin weave 120, and, hence, 4H. Naturally attendant to this nomenclature is the immediate capability of determining the percent wovenness of a satin weave and the unidirectional structures percentage; for example, a 4H is 25% woven and is 75% unidirectional structures.

Generally, satin weaves 120 are very flat, have good wet out and a high degree of drape, which means a high degree ability to conform to a complex surface. The low crimp gives good mechanical properties. Satin weaves 120 allow fibers to be woven in the closest proximity and can produce materials having fibers with a close ‘tight’ weave.

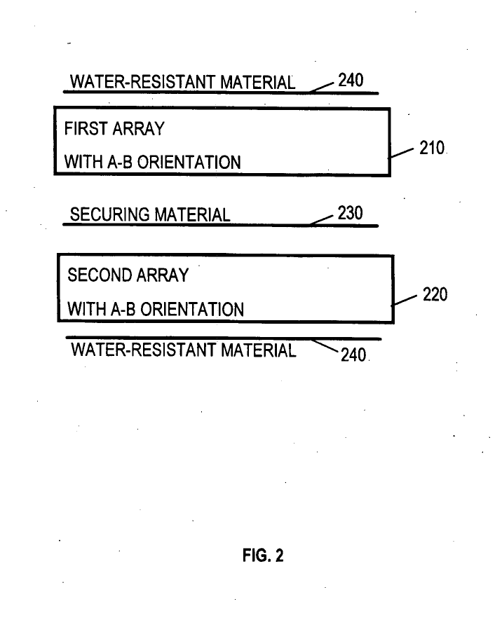

With the foregoing enabling discussion of weave patterns depicted in FIGS. 1A-1C, a more detailed discussion of the disclosed invention ensues by reference to FIG. 2. This Figure depicts an exploded, cross-sectional, side view of an embodiment of a laminate structure 200 suitable for antiballistic use or other high-modulus, high-strength applications. The first array 210 and the second array 220 are each materials having a substantially A-B (0°/90°) orientation of each material's component fibers. The materials, themselves, are non-plain woven, unspread fibered, high-modulus, high-strength materials, such as aramids, high-density polyethylenes, poly-p-phenylenebenzobisoxazoles, Twaron®, Zylon®, M5®, Kevlar®, and other materials capable of antiballistic uses. With the materials having the constraints mentioned in the previous two sentences, the first array 210 and the second array 220 are then cross-plied in a fashion that causes a repetition of each individual array's substantially A-B (0°/90°) orientation. As a result, the laminate structure 200 depicted in FIG. 2, and in accordance with the invention, has an A-B/A-B—not an A-B/B-A—orientation, wherein the arrays 210, 220 are affixed to each other with a securing material 230, such as a micropolythermic or thermoplastic film, e.g., polyethylene and polyurethane, or resin, e.g., an epoxy. The total weight amount of the securing material 230 in laminate structures 200 varies, but, for example, a two-ply array laminate structure 200 could be made with approximately ten percent or less the securing material 230; for laminate structures 200 with more than two plies, such may require more of the securing material 230, wherein “more” means as compared to the total weight of the laminate structure 200.

All embodiments of the invention, whether or not the laminate structure is composed of two, three, four, five, or more cross-plied arrays of non-plain woven, unspread fibered, high-modulus, high-strength materials have the repeated A-B orientation. Thus, for example, a three-array, cross-plied version of the laminate structure would have an overall A-B/A-B/A-B orientation, and additional cross-plied arrays follow the generalized overall orientation formula of [(A-B) times (number of arrays)]. Important to note is that the A-B orientation, especially when repeated by cross-plying with one or more additional arrays in the same A-B orientation, dissipates energy, such as from oncoming bullets, better than other orientations, such as A-B/B-A or A-B/B-A/A-B.

In some embodiments, the laminate structure may also include at least one plain-woven filament along at least one of the two orientations, i.e., the A and/or B direction (warp and/or weft) of the substantially A-B orientation. Such optional, plain-woven filament(s) is part of each array(s) in the laminate structure. Since the plain-woven filament(s) is woven in either the A or B orientation with respect to a specific array, its inclusion does not vitiate the overall, repeated A-B orientation of the laminate structure regardless of the number of cross-plied arrays. Instead, for example, the ballistic or non-ballistic plain-woven filament(s) may add strength to the laminate structure. Examples of plain-woven filaments include 70 denier nylon or cotton.

This disclosure now turns to even more specific embodiments of the invention. In one embodiment, a 1000 denier 4H satin weave aramid array and a 1000 denier 10H satin weave aramid array are cross-plied to form an A-B/A-B overall orientation, and uses a polymeric film or resin to secure the laminate structure into place. Typically, with two-array, non-plain-woven, cross-plied A-B/A-B systems, the laminate structure uses 30 g/m² or less of polymeric film or resin as the securing material. However, for systems having greater than such two arrays, the film or resin weight ratio to fiber weight may be at 15% or slightly greater in total weight. Additionally, for systems having greater than such two arrays, it may be desirable for interior arrays to be higher denier materials as compared to the arrays immediately flanking such an interior array, e.g., a 1140 or 1500 denier interior array flanked by 185 to 800 denier arrays for a three-ply laminate structure. In such embodiments, the higher denier interior array is wetted more easily with the securing material from the arrays immediately flanking such an interior array. Furthermore, the lower denier flanking arrays provide further support for the higher denier interior array, and, thereby, translate into added integrity for such laminate structures, especially when compared to the existing link points and securing material alone.

If the antiballistic material is hygroscopic, such as an aramid, then coating the laminate structure is advised. As shown in FIG. 2, the water-repellant coating 240 is applied to the exterior portions of the laminate structure 200 because water is known to impede antiballistic performance. If, however, the antiballistic material used to make the laminate structure 200 has low hygroscopicity or is non-hygroscopic, then addition of a water-repellant coating 240 may be superfluous, and, therefore, optionally omitted for inclusion as part of the laminate structure 200.

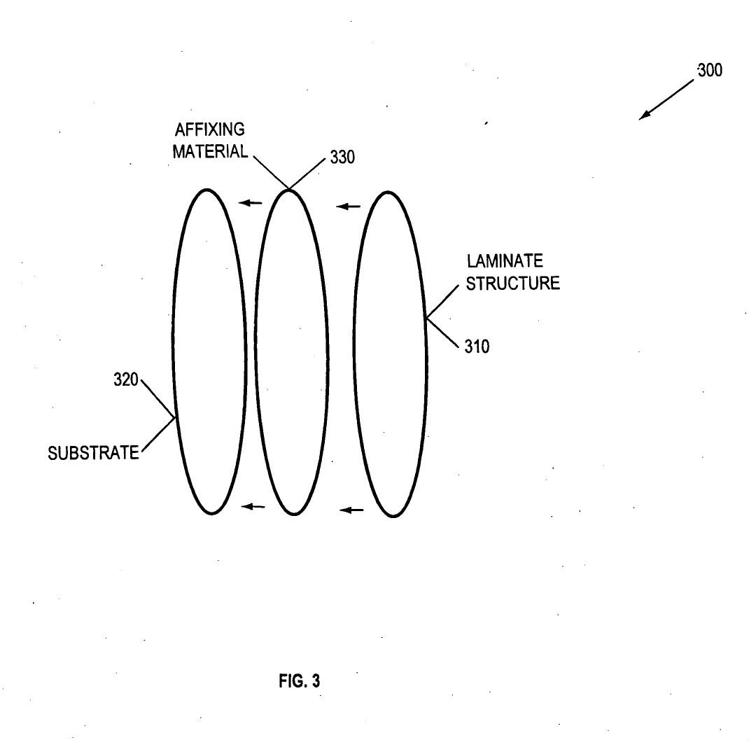

Manufacturing of the disclosed invention has revealed that the invention is pliable and formable into either sheet and rolled formats, wherein the latter especially provides for more time-efficient and ease in production of ultimate antiballistic applications or other high-modulus, high-strength, composite (i.e., draping) applications for the laminate structures. As depicted in FIG. 3, an embodiment of an armor plate 300 includes a substrate 320, such as metal or ceramic, affixed with an affixing material 330, such as an adhesive or Velcro®, to a laminate structure 310 to form the antiballistic device 300. As just implicitly stated, the affixing material 330 may be such so as to allow permanent or removable affixation of the laminate structure 310 to a substrate 320. In addition, and although not depicted, the laminate structure may be draped into shapes for uses requiring high-modulus, high-strength, composite applications other than for antiballistic purposes.

While the foregoing is directed to example embodiments of the disclosed invention, other and further embodiments of the invention may be devised without departing from the basic scope thereof, and the scope thereof is determined by the claims, which may be read in light of the foregoing disclosure, that follow.

What is claimed is:

1. A laminate structure comprising:
a first array having first, non-plain-woven fibers in a substantially A-B orientation;
a second array having second, non-plain-woven fibers in the substantially A-B orientation;
a securing material for adjoining the first array and the second array so that the laminate structure has a substantially A-B/A-B orientation.

2. The laminate structure of claim 1, further comprising additional arrays, wherein each of the additional arrays have additional, non-plain-woven fibers in the substantially A-B orientation, wherein the securing material adjoins the each of the additional arrays to the first array and the second array so that the laminate structure follows the substantially A-B/A-B orientation by an addition of the substantially A-B orientation for the each of the additional arrays.

3. The laminate structure of claim 2, wherein the securing material comprises a micropolythermic film.

4. The laminate structure of claim 1, further comprising at least one plain-woven filament along at least one of the two orientations of the substantially A-B orientation.

5. The laminate structure of claim 4, wherein the at least one plain-woven filament comprises a 70 denier nylon.

6. The laminate structure of claim 4, wherein the at least one plain-woven filament comprises a ballistic yarn.

7. The laminate structure of claim 4, wherein the at least one plain-woven filament comprises a coated yarn.

8. The laminate structure of claim 1, further comprising a water-repellent coating on the exterior portions of the laminate structure.

9. The laminate structure of claim 1, wherein the non-plain woven fibers comprise woven and non-woven component fibers.

10. The laminate structure of claim 1, wherein the first array and the second array comprise low hygroscopic materials.

11. The laminate structure of claim 1, wherein the first array and the second array comprise one or more materials selected from the group consisting of aramids, high-density polyethylenes, poly-p-phenylenebenzobisoxazoles, Twaron®, Zylon®, M5®, carbon nanotubes, and Kevlar®.

12. The laminate structure of claim 1, wherein the first array and the second array comprise one or more types of antiballistic materials.

13. The laminate structure of claim 1, wherein the first array and the second array comprise one or more types of high-modulus, high-strength fibers.

14. The laminate structure of claim 1, wherein the non-plain-woven fibers of the first array comprise a weave pattern having link points uniformly distributed throughout the substantially A-B orientation.

15. The laminate structure of claim 1, wherein the non-plain-woven fibers of the second array comprise a weave pattern having link points uniformly distributed throughout the substantially A-B orientation.

16. The laminate structure of claim 1, wherein a weave pattern for the non-plain-woven fibers comprises a range of a 4H weave to a 20H weave.

17. The laminate structure of claim 1, wherein the laminate structure comprises an antiballistic structure.

18. The laminate structure of claim 1, wherein the laminate structure comprises a high-strength composite structure capable of draping into desired shapes.

19. The laminate structure of claim 1, wherein the laminate structure is affixed to one or more substrates for an antiballistic application.

20. The laminate structure of claim 19, wherein the one or more substrates comprise metal.

21. The laminate structure of claim 19, wherein the one or more substrates comprise ceramic.

22. The laminate structure of claim 1, wherein the securing material comprises a polyethylene film.

23. The laminate structure of claim 1, wherein the securing material comprises a polyurethane film.

24. The laminate structure of claim 1, wherein the securing material comprises a resin.

25. The laminate structure of claim 24, wherein the resin comprises an epoxy.

26. The laminate structure of claim 25, wherein the epoxy comprises a carbon nanotube impregnated epoxy.

27. The laminate structure of claim 1, wherein the securing material comprises a thermoplastic material.

28. The laminate structure of claim 27, wherein the thermoplastic material comprises a carbon nanotube impregnated polymeric film.

29. The laminate structure of claim 1, wherein the laminate structure is in a sheet format.

30. The laminate structure of claim 1, wherein the laminate structure is in a roll format.

31. The laminate structure of claim 1, wherein the non-plain-woven fibers are unspread.

32. The laminate structure of claim 1, wherein the first array and the second array comprise different deniers.

33. The laminate structure of claim 1, wherein both the first array and the second array comprise 1000 denier aramid fabrics.

34. The laminate structure of claim 1, wherein both the first array and the second array comprise 840 denier aramid fabrics.

35. The laminate structure of claim 1, wherein both the first array and the second array comprise materials in a range of between 185 to 3000 denier.

36. The laminate structure of claim 1, wherein the laminate structure comprises a pliable structure.

37. The laminate structure of claim 1, wherein the non-plain-woven fibers comprise a low-crimping-fiber weave.

38. The laminate structure of claim 37, wherein the low-crimping-fiber weave comprises a twill-based weave.

39. The laminate structure of claim 1, wherein the securing material comprises a weight of approximately ten percent or less of the laminate structure having only the first array and the second array.

40. The laminate structure of claim 1, wherein a weave pattern for the non-plain-woven fibers comprises a weave having one harness link point described by a formula of width of fabric multiplied by number of ends plus one and then dividing the product by two and placing “H” by the quotient.

41. The laminate structure of claim 1, wherein a weave pattern for the non-plain-woven fibers comprises a range of a 4H weave to a weave having one harness link point described by a formula of width of fabric multiplied by number of ends plus one and then dividing the product by two and placing “H” by the quotient.
